(19) United States
(12) Patent Application Publication
(10) Pub. No.: US 2026/0034907 A1
(43) Pub. Date: Feb. 5, 2026

(54) Positioning Support System for Positioning a Motor Vehicle at a Charging Station, Corresponding Method, and Corresponding Software and Data Memory Suitable Therefor

(71) Applicant: Bayerische Motoren Werke Aktiengesellschaft, Muenchen (DE)

(72) Inventor: Kilian DETTLAFF, Muenchen (DE)

(21) Appl. No.: 18/994,800

(22) PCT Filed: Jun. 21, 2023
(86) PCT No.: PCT/EP2023/066719

§ 371 Date: Jan. 15, 2025

(30) Foreign Application Priority Data
Jul. 21, 2022 (DE) 10 2022 118 317.3

(51) Int. Cl. B60L 53/37; B60L 53/18; B60L 53/36

(52) U.S. Cl. CPC B60L 53/37; B60L 53/18; B60L 53/36; B60L 2250/16

(57) ABSTRACT

A positioning support system for a motor vehicle including an electric drive, having an indicating function for supporting the driver when positioning at a charging station which is suitable for charging the motor vehicle via a charging cable. The positioning support system is configured to determine environmental information relating to the environment of the vehicle by a vehicle-side environment sensor system, to determine an environment visualization of the vehicle environment based on the environmental information with a visualization of the range of a charging cable, and to display the determined environment visualization on a display device.

### BACKGROUND AND SUMMARY

The invention relates to a positioning support system for a motor vehicle, in particular a passenger vehicle, having electric drive (for example, an electric vehicle or plug-in hybrid vehicle), having an indicating function for supporting the driver when positioning at a charging station, which is used to charge the motor vehicle via a charging cable. Furthermore, the invention relates to a corresponding method and corresponding software as well as a vehicle-external data memory suitable therefor.

For motor vehicles having electric drive, the electrical energy storage device of which can be externally charged at a charging station, for example, at a public charging column, the motor vehicle has to be positioned at the charging station before charging, specifically within the range of the charging cable used for charging and forming the electrical connection between the electrical charging connection of the vehicle and the charging column. The primary application scenario of the invention relates to charging cables associated with the charging station; however, it would also be possible to use the invention for a charging cable carried along in the vehicle. Positioning the motor vehicle at a charging station is difficult for the driver: If the vehicle is parked too far away from the charging column, the charging cable does not reach to the charging connection of the ego vehicle, so that the driver has to get into the vehicle again and has to move the vehicle closer to the charging station. If the vehicle is parked too close to the charging station, a collision can occur.

The problem is made more severe in that the length of such charging cables associated with the respective charging station is not the same for all charging stations and depends, for example, on the charging standard used or on the country or the region.

Maneuvering support systems having a function for visualizing the surroundings of a motor vehicle in a surroundings display are known from the prior art, for example, for parking. Such surroundings displays are often a so-called top view display, in which the surroundings are observed from the view from above (also referred to as a top view display). The surroundings display often also comprises a visual vehicle representation of the motor vehicle from the view from above in this case. In camera-based surroundings displays, for example, the image of multiple cameras pointing in different directions can be superimposed for the surroundings display, for example, the image of two exterior mirror cameras directed toward different sides, the image of a reversing camera directed to the rear, and optionally the image of a front camera directed forward.

Known surroundings displays can additionally have vehicle-specific markings as indications for the driver, e.g., the location of the trailer hitch, the location of the tires, or the trajectory to be expected with given steering angle.

It is an object of the invention to support the driver when positioning the motor vehicle at a charging station.

The object is achieved by the features of the independent claims. Advantageous embodiments are described in the dependent claims. It is noted that additional features of a claim dependent on an independent claim, without the features of the independent claim or only in combination with a subset of the features of the independent claim, can form a separate invention independent of the combination of all features of the independent claim, which can be made the subject matter of an independent claim, a divisional application, or a subsequent application. This applies in the same manner to technical teachings which are described in the description and can form an invention independent of the features of the independent claims.

A first aspect of the invention relates to a positioning support system for a motor vehicle, in particular a passenger vehicle, having electric drive (for example, an electric vehicle or plug-in hybrid vehicle), having an indicating function for supporting the driver when positioning at a charging station suitable for charging the motor vehicle via a charging cable. The positioning support system is preferably used for the application scenario that the charging station is a public charging station and the charging cable is a charging cable associated with the charging station (i.e. the charging cable is not carried along by the ego vehicle).

The positioning support system is configured to carry out various activities described hereinafter. This is typically carried out by means of one or more software-controlled devices, in particular electronic control units. Each of the one or more software-controlled devices can comprise one or more programmable processors which operate according to the invention in a program-controlled manner via one or more software programs.

The positioning support system is configured to determine surroundings information relating to the surroundings of the motor vehicle by means of a vehicle-side surroundings sensor system (for example, camera sensor system and/or ultrasonic sensor system) and to determine surroundings visualization of the vehicle surroundings based on the surroundings information (i.e., to determine corresponding image data for display on a display device). The surroundings visualization is, for example, a view from above (also referred to as a top view) having a vehicle representation of the ego motor vehicle, in which the images of multiple cameras pointing in different directions are superimposed, for example, the image of two exterior mirror cameras directed to the left and right, the image of a reversing camera directed to the rear, and optionally the image of a front camera directed forward.

The surroundings visualization also comprises visualization of a range of the charging cable here, typically by means of marking of a specific surrounding area indicating the range in the surroundings visualization.

The determined surroundings visualization is displayed on a display device (typically arranged in the vehicle cockpit), for example, on a central display screen in the vehicle cockpit.

The positioning support system according to the invention facilitates the positioning of the ego vehicle at the charging station for the driver by visualizing the range of the charging cable, by marking of a specific area indicating the range in the surroundings visualization, so that the vehicle can easily be parked with its charging connection within the range of the charging cable.

Fundamentally, two fundamental approaches are conceivable for the visualization of the range of the charging cable:

In a preferred first approach, a range is indicated in the form of a marked surrounding area in relation to a charging connection of the motor vehicle, i.e. the charging connection of the motor vehicle forms the reference point for the range. For this purpose, surroundings information relating to a charging station in the surroundings of the motor vehicle is determined and visualization of the position of the charging station in the surroundings visualization is provided based thereon. To visualize the position of the charging station, for example, the camera image of the charging station can be displayed in the correct position in relation to the position of the ego motor vehicle. The charging station or a single reference point at the charging station (for example, the location of the connection point of the charging cable to the charging column) can also be highlighted in the camera image by a suitable marking. The charging connection of the motor vehicle is located in the range of the charging cable when the visualized position of the charging station (for example, the indicated charging station) is located within the marked surrounding area of the range of the charging cable. For example, if a charging station visible in the surroundings visualization is located within a marked area of the charging cable range, it can be assumed that the vehicle is close enough to the charging station. It is advantageous if the surroundings visualization comprises a visual vehicle representation of the motor vehicle or a part of the motor vehicle (which is typically displayed on the display device at a position independent of the movement of the motor vehicle) and the marked surrounding area, which indicates the range, marks an area adjacent to the visual vehicle representation, specifically at least adjacent to that side of the vehicle on which the vehicle-side charging connection is located. In addition, it would be conceivable to mark a surrounding area adjacent to the other side of the vehicle, specifically for the application that the charging cable is laid transversely over the vehicle by the user if the charging station is not located on the side of the vehicle-side charging connection.

If the motor vehicle has multiple charging connections at various positions of the motor vehicle, a separate visualization of a range of a charging cable in relation to the respective charging connection can be provided in the surroundings visualization for each charging connection.

The geometry of the indicated charging cable range can take into consideration the geometrical conditions: For example, the indicated range can be different for various directions from the charging connection, greater for a direction orthogonal to the vehicle longitudinal axis than for a direction parallel to the vehicle longitudinal axis. This is because if the charging plug has to be plugged perpendicularly into the charging socket on the vehicle, for example, the range is longer perpendicular to the vehicle longitudinal axis than parallel to the vehicle longitudinal axis.

Alternatively, it would be conceivable in a second approach to display the range in relation to the charging station, i.e., the charging station forms the reference point for the range. In this case, the surroundings visualization comprises visualization of the position of the vehicle-side charging connection. The vehicle is parked sufficiently close to the charging station, for example, if the visualized position of the vehicle-side charging connection is located within the marked surrounding area of the range of the charging cable.

For both approaches, it is advantageous if the motor vehicle determines position information relating to the position of the motor vehicle or a charging station located in the surroundings of the motor vehicle, and to provide the position information for a data memory for determining charging cable length information relating to the length of a charging cable based on the position information.

The position information of the ego motor vehicle can be produced by means of a global navigation satellite system for position determination (for example, GPS). The position of a charging station located in the surroundings can be determined, for example, by determining the position of the ego motor vehicle by means of a global navigation satellite system and determining a position offset of the charging station in relation to the position of the ego motor vehicle. Furthermore, it would be possible to receive position information of a charging station located in the vicinity at the vehicle via radio from the charging station.

The data memory is preferably a vehicle-external data memory in the backend, for example, having stored positions of the charging stations and associating charging cable lengths. The data memory accepts, for example, the position information determined by the vehicle and relating to the position of the motor vehicle via a complex communication network and determines the closest stored position and the charging cable length associated with this stored position and provided to the vehicle via a complex communication network. The determined charging cable length information is then accepted by the positioning support system of the to determine depending thereon the visualization of the range of the charging cable depending on the charging cable length information. Of course, the data memory can also be a vehicle-internal data memory.

For the case that no position information is determinable or no charging cable length information depending on the position information is available, the visualization of the range of the charging cable can be determined depending on an assumed standard charging cable length.

It is advantageous to determine range information relating to the range of the charging cable based on charging cable length information, specifically in consideration of
one or more properties of the motor vehicle, such as the vehicle height, the vehicle width, the height of the vehicle-side charging connection, and/or the alignment of the vehicle-side charging connection,
one or more properties of the charging station, such as the height of the charging station-side charging connection, and/or
one or more further properties (in addition to the charging cable length) of the charging cable (for example, flexibility).

It can thus be provided that charging cable length information converts into range information in terms of an effective range in accordance with the vehicle properties and possibly in consideration of further parameters (for example, relating to the charging station and/or the charging cable).

Based on the range information and the surroundings information (for example, camera data), surroundings visualization can then be rendered, which is displayed on the display device.

A second aspect of the invention relates to a method for positioning support in a motor vehicle having electric drive when positioning at a charging station, which is used for charging the motor vehicle via a charging cable, comprising the following steps:
determining surroundings information relating to the surroundings of the motor vehicle by means of a vehicle-side surroundings sensor system;
based on the surroundings information, determining surroundings visualization of the vehicle surroundings having visualization of a range of a charging cable; and
displaying the determined surroundings visualization on a display device.

The above statements on the positioning support system according to the invention according to the first aspect of the invention also apply correspondingly to the method according to the invention according to the second aspect of the invention. Advantageous exemplary embodiments of the method according to the invention which are not explicitly described at this point and in the claims correspond to the advantageous exemplary embodiments of the positioning support system according to the invention which are described above or described in the claims.

A third aspect of the invention relates to software having program code for carrying out the method according to the second aspect of the invention when the software runs on one or more software-controlled devices. A software-controlled device preferably comprises one or more programmable processors, which process the program code of the software loaded into a working memory.

Furthermore, the invention relates to a computer-readable (storage) medium which comprises the software.

A further aspect of the invention relates to a vehicle-external data memory for providing charging station-specific charging cable length information relating to the respective length of a charging cable, wherein the data memory is configured
to accept position information relating to the position of a motor vehicle or a charging station located in the surroundings of the motor vehicle,
to determine charging cable length information relating to the length of a charging cable based on the position information, and
to output the determined charging cable length information with the goal of transmission to the motor vehicle.

Advantageous embodiments of the data memory were explained in conjunction with the first aspect of the invention.

The invention will be described hereinafter on the basis of an exemplary embodiment with the aid of the appended drawings. In the figures:

### BRIEF DESCRIPTION OF THE DRAWINGS

FIG. 1 shows an exemplary embodiment of a positioning support system according to the invention; and

FIG. 2 shows an exemplary surroundings visualization displayed on a display screen.

### DETAILED DESCRIPTION OF THE DRAWINGS

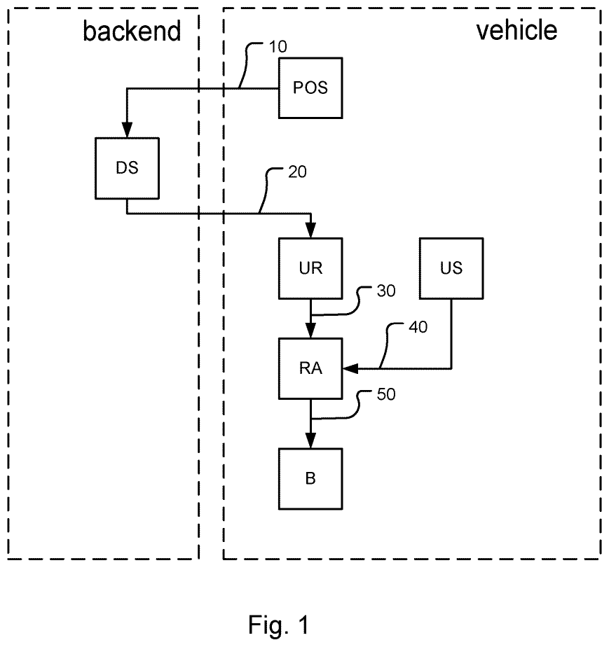

FIG. 1 shows an exemplary embodiment of a positioning support system according to the invention for a motor vehicle. In the vehicle, a position determination function POS carries out a determination of the position of the ego vehicle by means of a global navigation satellite system for position determination (e.g., GPS, Galileo, GLONASS, Beidou). The resulting position information 10 relating to the position of the motor vehicle is transmitted to a data memory DS in the backend, which contains stored positions of the charging stations and associated charging cable lengths. The data memory DS determines the stored position of a charging station closest (to the position of the motor vehicle) based on the position information 10 and the charging cable length information 20 associated with this stored position and relating to the charging cable length of the charging station at this stored position. The determined charging cable length information is transmitted to the vehicle. In a conversion function UR, the charging cable length information 20 is converted into range information 30 relating to the range of the charging cable depending on vehicle-specific properties and possibly properties of the charging station/the charging cable (which are preferably transmitted from the backend into the vehicle). In a surroundings sensor system function US, surroundings information 40 is determined by means of multiple vehicle-side cameras directed in various directions, for example, by means of two exterior mirror cameras directed to the left and right, a reversing camera directed to the rear, and a front camera directed forward. In a rendering function RA, based on the range information 30 and the surroundings information 40, a surroundings visualization 50 having a visualization of the range of the charging cable of the respectively closest charging station is rendered, which is displayed on a display screen B in the vehicle cockpit.

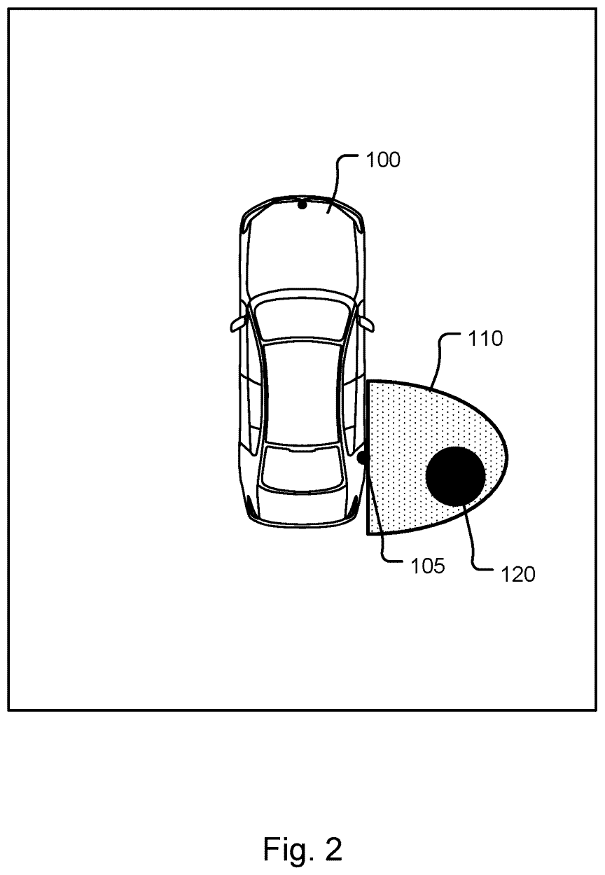

FIG. 2 shows an exemplary surroundings visualization 50 displayed on a display screen B. The surroundings visualization comprises a visual vehicle representation 100 of the motor vehicle and a marked surrounding area 110 in the surroundings visualization 50, the boundary of which indicates the range of the charging cable of the charging station. Furthermore, it is visualized in the surroundings visualization of the position of the charging station, for example, in that the camera image of the charging station 120 is displayed at the correct position in relation to the ego vehicle position. For better recognizability for the driver, the displayed charging station can also be especially highlighted in the camera image by a marking. Alternatively, the charging station could also be displayed at the correct position solely schematically in the surroundings visualization. Preferably, the vehicle-side charging connection 105 is especially highlighted in the displayed vehicle representation 100.

If the displayed charging station 120 is located within the marked surrounding area 110, the charging connection 105 of the vehicle is located in the range of the charging cable and the vehicle can be charged.

1.-14. (canceled)

15. A positioning support system for a motor vehicle having electric drive, having an indicating function for supporting a driver when positioning at a charging station suitable for charging the motor vehicle via a charging cable, wherein the positioning support system is configured to:
determine, by a vehicle-side surroundings sensor system, surroundings information relating to surroundings of the motor vehicle;
based on the surroundings information, determine a surroundings visualization of the vehicle surroundings having a visualization of a range of a charging cable; and
display the determined surroundings visualization on a display device.

16. The positioning support system according to claim 15, wherein the surroundings visualization is configured such that the range is visualized in relation to a charging connection on the motor vehicle.

17. The positioning support system according to claim 15, wherein the positioning support system is configured to:
determine, by the surroundings sensor system, surroundings information relating to a charging station in the surroundings of the motor vehicle, and
based on the surroundings information relating to the charging station in the surroundings visualization, provide a visualization of the position of the charging station.

18. The positioning support system according to claim 16, wherein the positioning support system is configured to:
determine, by the surroundings sensor system, surroundings information relating to a charging station in the surroundings of the motor vehicle, and
based on the surroundings information relating to the charging station in the surroundings visualization, provide a visualization of the position of the charging station.

19. The positioning support system according to claim 15, wherein the surroundings visualization is designed such that
the visualization of the range of the charging cable is carried out by a marked surrounding area in the surroundings visualization, and
the motor vehicle is located in the range of the charging cable when the visualized position of the charging station is located in the marked surrounding area.

20. The positioning support system according to claim 16, wherein the surroundings visualization is designed such that
the visualization of the range of the charging cable is carried out by a marked surrounding area in the surroundings visualization, and
the motor vehicle is located in the range of the charging cable when the visualized position of the charging station is located in the marked surrounding area.

21. The positioning support system according to claim 19, wherein
the surroundings visualization comprises a visual vehicle representation of the motor vehicle or a part of the motor vehicle, and
the marked surrounding area marks at least one area adjacent to the visual vehicle representation.

22. The positioning support system according to claim 16, wherein the surroundings visualization is configured such that the indicated range is different for different directions from the charging connection and is greater for a direction orthogonal to the vehicle longitudinal axis than for a direction parallel to the vehicle longitudinal axis.

23. The positioning support system according to claim 17, wherein the surroundings visualization is configured such that the indicated range is different for different directions from the charging connection and is greater for a direction orthogonal to the vehicle longitudinal axis than for a direction parallel to the vehicle longitudinal axis.

24. The positioning support system according to claim 18, wherein the surroundings visualization is configured such that the indicated range is different for different directions from the charging connection and is greater for a direction orthogonal to the vehicle longitudinal axis than for a direction parallel to the vehicle longitudinal axis.

25. The positioning support system according to claim 16, wherein the motor vehicle has multiple charging connections and the surroundings visualization has multiple marked surrounding areas, wherein each of these marked surrounding areas indicates the range in relation to one of the charging connections.

26. The positioning support system according to claim 18, wherein the motor vehicle has multiple charging connections and the surroundings visualization has multiple marked surrounding areas, wherein each of these marked surrounding areas indicates the range in relation to one of the charging connections.

27. The positioning support system according to claim 15, wherein the positioning support system is configured to:
receive charging cable length information relating to as length of a charging cable,
based on the charging cable length information, determine range information relating to the range of the charging cable, in consideration of:
one or more properties of the motor vehicle, including the vehicle height, the vehicle width, the height of the vehicle-side charging connection, and/or the alignment of the vehicle-side charging connection,
one or more properties of the charging station, including the height of the charging station-side charging connection, and/or
one or more further properties of the charging cable.

28. The positioning support system according to claim 15, wherein the positioning support system is configured to:
determine position information relating to the position of the motor vehicle or a charging station located in the surroundings of the motor vehicle,
provide the position information for a vehicle-external or vehicle-internal data memory to determine charging cable length information relating to a length of a charging cable based on the position information,
receive the determined charging cable length information, and
determine the visualization of the range of the charging cable as a function of the charging cable length information.

29. The positioning support system according to claim 28, wherein the positioning support system is configured to:
establish that position information is determinable or no charging cable length information is available as a function of the position information, and
in a case of establishing that the position information is determinable or no charging cable length information is available as a function of the position information, determine the visualization of the range of the charging cable as a function of standard charging cable length information.

30. The positioning support system according to claim 15, wherein the charging cable is a charging cable associated with the charging station.

31. A method for positioning support for a motor vehicle having electric drive when positioning at a charging station, which is used for charging the motor vehicle via a charging cable, the method including:
determining, by a vehicle-side surroundings sensor system, surroundings information relating to surroundings of the motor vehicle;
based on the surroundings information, determining a surroundings visualization of the vehicle surroundings having a visualization of a range of a charging cable; and
displaying the determined surroundings visualization on a display device.

32. A non-transitory computer-readable medium storing a program for providing charging station-specific charging cable length information relating to a length of a charging cable to motor vehicles, which each have a positioning support system, wherein the program causes a computer to:
receive position information relating to a position of a motor vehicle or a charging station located in surroundings of the motor vehicle,
determine charging cable length information relating to a length of a charging cable based on the position information, and
output the determined charging cable length information to the motor vehicle.
